(19) United States
(12) Patent Application Publication
(10) Pub. No.: US 2005/0021338 A1
(43) Pub. Date: Jan. 27, 2005

(54) Recognition device and system

(76) Inventors: Dan Graboi, Encinitas, CA (US); John Lisman, Watertown, MA (US)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 10/801,099

(22) Filed: Mar. 15, 2004

Related U.S. Application Data
(60) Provisional application No. 60/455,282, filed on Mar. 17, 2003.

(51) Int. Cl. G10L 15/14

(52) U.S. Cl. 704/256

(57) ABSTRACT

A recognition system that operates in an iterative process on detected features progressively setting a detection window for enhancing the recognition process. The process allows integration over multiple samples of the detection window until recognition occurs. In each iteration, a measure or distribution determined by the remaining set of candidate objects is used to redirect the window of attention, which is preferably directed to a feature at one level, with a weighting such that detection of the feature or confirmation of its absence more efficiently winnows the remaining candidate set. The active set of candidate objects is quickly reduced as inspection of targeted features proceeds.

### BACKGROUND OF THE INVENTION

A treatise that sets forth a consistent and complete description of the logical interrelations and operations for carrying out recognition tasks in accordance with the method of the invention is attached hereto as Appendix A. That document is hereby incorporated herein by reference in its entirety.

The present invention relates to perception and the movement of attention to optimize recognition or detection of contextually relevant objects. It relates to the recognition or detection of an object or event, and of features, states or particular qualities of an object or event that are available for recognition. It also relates to pattern recognition, or the detection of a pattern in an object or set of objects, event or set of events.

Object recognition or pattern detection systems are widely used in a number of fields such as the detection of military equipment in images for reconnaissance purposes, or the recognition of geographic areas where underground oil may be present. In addition, detection and recognition are required in robotic autonomous agents to allow them to perform desired tasks and react rapidly and successfully to changing high level contextual constraints. This device directs attention movement efficiently to gather relevant or important information with respect to a specified set of high-level contextual constraints—for example, finding an exemplar of a particular category in a cluttered environment containing many non-category exemplars. The device also has the capability of setting high level contextual information by recognizing an object or objects and generalizing to the context.

On a somewhat less intuitive level, recognition systems are also directed to certain areas in which large numbers of formal objects or physical substances are to be inspected, by analytic probe techniques or by modeling techniques, to identify one or more candidate objects having a desired or hypothesized property or set of features. The search for new drugs and the modeling of molecular conformation for complex peptides or other compounds are examples of such recognition systems. For these tasks, one may seek to identify the structure of a compound that will exhibit certain behavior.

Alternatively, when there exists a large database of materials or events whose features have been characterized, one may seek to identify which member of the database corresponds to a presented sample, methodically inspecting a small number of its features. Such is the task of classical qualitative analysis in inorganic chemistry, a field where a number of highly determinative test protocols have been developed. For classical organic chemistry a similar problem may be attacked using features of the sample material such as its infrared spectrograph, while for peptides and other life compounds the task becomes more complicated and multidimensional.

In the domain of sounds, patterns comprised of auditory features in an auditory event may be detected, leading to recognition of words in speech, or signatures of specific animals or machines, such as submarines. Since speakers of different dialects produce words and word features in different patterns, a useful recognition device would be one capable of recognizing the place of origin of a speaker.

In addition to areas such as object identification and image recognition, numerous modern technologies require specialized or advanced forms of pattern recognition applied to data sets. The data sets may be catalogues or compilations from diverse sources. For example, document information may be inspected for containing information relevant to search criteria. As another example, sensor array outputs or survey records may be inspected to identify patterns not directly measured by the sensors or not initially contemplated by the original questionnaires or data entry. Similarly, “object records” may be constructed from plural sources such as registries of earnings, birth records, residence, presentation at medical institutions or other large public data bases to provide one or more multi-parameter data sets from which patterns are to be extracted or in which particular records or records having specific properties are to be identified.

Recently, much of the underlying data generation, database construction and pattern searching has become highly automated. However, while computers are capable of great speed in processing large sequences of instructions, the amount of data present in many recognition tasks, or the nature of the computational testing or transformations required for different steps of the recognition task continually challenges the limits of these systems and requires a continued search for efficient steps and new approaches to detection, recognition and identification in general.

Various theories of perception, recognition and attention have been proposed, and these are discussed in Appendix A.

Accordingly, it would be desirable to provide a device or system for pattern recognition.

It would also be desirable to provide a recognition system with a structure that is both generally adaptable and efficient in operation.

It would also be desirable to provide a recognition system with an architecture that is adaptable to diverse different detection, recognition and perception tasks.

### SUMMARY OF THE INVENTION

One or more of these and other desirable ends are obtained in a recognition system which supports efficient movement of attention based on high level contextual constraints. This movement of attention operates in part as a result of bidirectional signal flow within a hierarchical memory module (HM). Within the hierarchically structured neural-style network are populations of nodes, which may be active at various extents, at various levels of abstraction from the lowest level. At the lowest level of HM are nodes for basic features, such as line segments for visual information or basic phonetic sounds for auditory information. The next level up in the hierarchical memory structure is composed of combinations of features from the level below, such as letter shape information for visual information and phonemes for auditory information. Each successive level of abstraction encodes combinations of units found in the previous level.

The invention contemplates a Top-Down processing in the HM which operates, for example to assign a measure to each feature, such as a probability-type measure. The measure may correspond to the fraction of not-yet excluded complex objects containing the feature. This measure computed for each feature in an array defines a landscape of feature measures, which, in one practice of a recognition process or device according to the invention comprises a “high-level input” (T-D input) fed into a Selective Attention Module (SAM).

At the same time, a corresponding array of outputs from a Front End Module (FEM), such as a feature detector that operates on features of an item presented for recognition, is fed into the Bottom-Up (B-U) input of the SAM. Each output may represent whether a specific feature is present or absent in the object being recognized. A decision function operates within the SAM to select which FEM feature signal next to connect or “gate” into the B-U input of HM. Once gated into HM, this new signal is processed B-U in HM. Performing consistency computations at each successive level (using the connectivities), the result is that at all levels, culminating in the top level, a set of candidates which were possible before the new feature information was processed becomes excluded.

A new T-D signal processing step initiates in HM, resulting in a new T-D landscape input to the T-D input of the SAM. The iterative process, which involves high level contextual constraints, signal processing within HM, signal processing within the FEM, and signal processing within the SAM operates to set the next window (that is, to determine the next targeted feature) in a manner as to enhance the information gleaned in previous iterative steps. The selective attention process, performed in each iterative step, allows integration over multiple samples to progressively exclude inconsistent candidate objects until the ensemble of candidates has a single object and recognition occurs. In a preferred system, attention is directed to a feature with a weighting such that detection of the feature (intuitively, if the feature is a rare feature), or confirmation of its absence (if the feature is a common feature), efficiently winnows the candidate set as inspection of targeted features proceeds.

In prototype simulation model, signal flow in the Top Down (T-D) direction performs linear summation computations and normalization, while signal flow in the Bottom Up (B-U) direction performs logical consistency computations. Other types of computations in T-D and B-U signal flow directions are not excluded where they may accomplish equivalent results with respect to the movement of attention and winnowing of candidates.

Since high-level constraints are used to influence which low-level features are attended, the system has the ability to “ignore” or filter out features not relevant to the current task as defined by the high-level contextual constraints. Thus additional efficiency is gained since less processing time is not devoted to signals from the FEM which are not relevant.

The foregoing operation is schematically illustrated in attached FIGURE A.

### BRIEF DESCRIPTION OF THE DRAWINGS (FIGS. 1-5 ARE FOUND IN APPENDIX A; FIGURE A IS ATTACHED)

These and other features of the invention will be understood from the description and claims below, taken together with the figures showing illustrative embodiments, wherein:

FIG. 1 illustrates the database structure and flow of information in one embodiment of an object identification system of the present invention;

FIG. 2 illustrate rules of connectivity between levels for the system of FIG. 1;

FIG. 3 illustrates detailed steps in the recognition process and iterative accumulation of information at all levels of the system shown in FIGS. 1 and 2;

FIGS. 4A and 4B illustrate time-dependent changes during recognition, with and without contextual information for a bidirectional mismatch feature window;

FIG. 5 charts a comparison of efficiency in producing recognition, of different feature selection regimens;
Figure A illustrates the relationship between the Hierarchical Memory (HM) module, the Selective Attention Module (SAM) and the Front End Module (FEM).

### DETAILED DESCRIPTION OF THE INVENTION

The present invention provides an improved detection system for the recognition or detection of targets using static or dynamic contextually constrained information. The system operates with a database organized as a hierarchy of interconnected nodes at different levels, and proceeds by selectively focusing attention on portions of the contextually relevant object or data structure to identify it as one of a number of objects initially present in a database. The system may also make determinations that the stimulus is not present in the database, if that is the case. Operation and structure of systems of the invention will be explained below in part by analogy to a theory of human perception and recognition, together with examples of computer-implemented recognition devices directed to simple objects.

A starting point is the observation that human visual perception can in fact focus attention on rather small details; it proceeds by selectively glancing at details in order to perceive or recognize the larger object or scene. A theory governing how attention is directed to those details in a context-dependent manner is applied herein to produce an automated recognition device of enhanced capabilities.

Applicants here propose a model that produces well-determined results and readily translates into a novel structure for a computerized recognition system capable of identifying a presented object or stimulus as being one of the objects in a large and intricately organized database.

This process, and the underlying structure of recognition systems in accordance with the present invention, will be best understood from the description of a device and model for carrying out a simple recognition task, which in the example discussed below is a word recognition task. The underlying data hierarchy has feature, letter and word levels. The recognition processor seeks to identify a presented stimulus, e.g., a word, with an entry in a database or stored set of words, employing a sensor which, in this case, is an image processing subroutine operative to identify fragments or details of letters in subframes or small image regions.

Initially, all nodes representing each possible word are assumed to be “active”, or to be members of the candidate set at the start of the recognition processing. A movable window of attention is defined to focus on particular visual features. Thus, an elementary arc, segment or vertex feature forming one of the handful of basic graphic components of a letter may constitute the features at the lowest level of a word recognition module. Letters are at the next highest level up from features, consisting of a combination of features, and at the next highest level, words themselves consist of combinations of letters. At a level higher than the word level may be word category, such as “animal words” or “nouns.”

To provide a concrete framework for exploring hierarchical processing, applicants used a simplified model of word recognition based on the work of Rumelhart and collaborators (Rumelhart 1971; Rumelhart and Siple 1974; McClelland and Rumelhart 1981; Rumelhart and McClelland 1982). To this model applicants added an attention mechanism that feeds information from the feature level to higher levels only in a selected window of attention that is moved serially during the recognition process. Using this model it is possible to compare the efficiency of different methods for moving the window and to test whether the model can account for basic properties of word recognition. The model does not deal with many of the complexities of real world vision including scaling, rotation, letter variation and noise. This is appropriate since the experiments sought to account for did not involve these complexities.

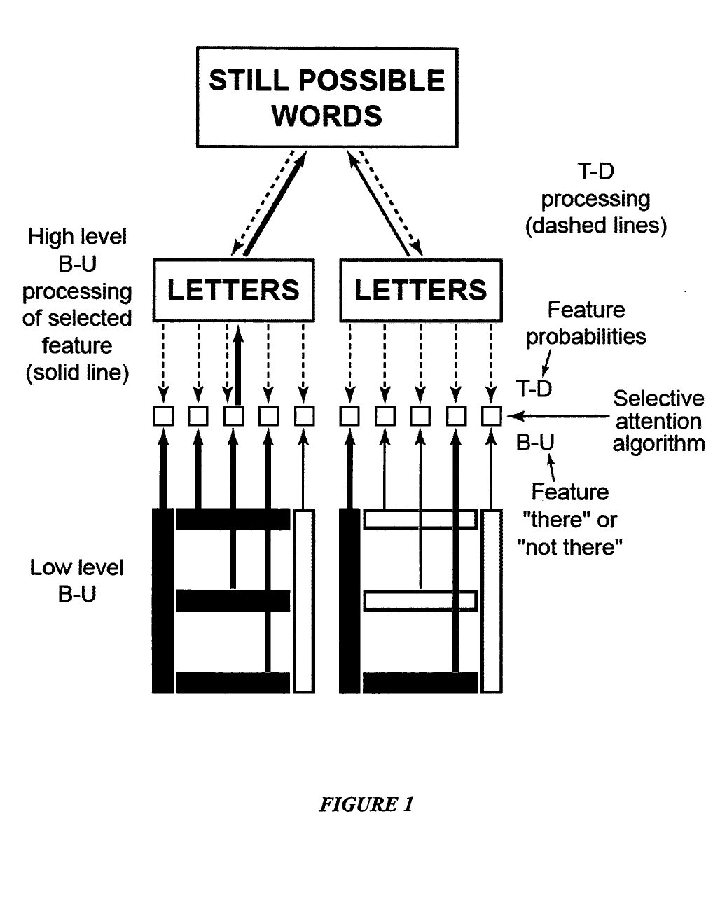

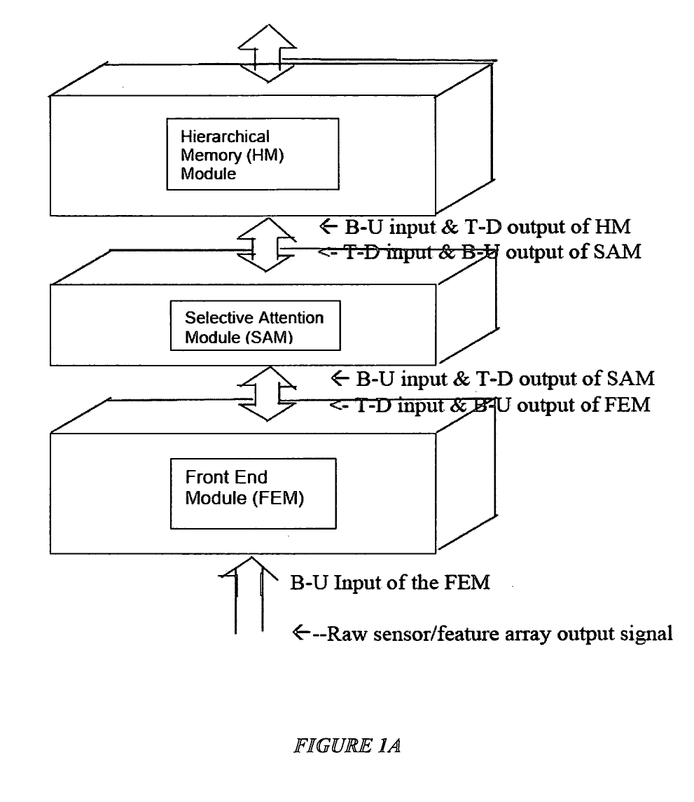

The general idea is as follows. The network has three hierarchical levels corresponding to the feature, letter and word levels. Nodes at the “word” level are active at the beginning of the recognition process, provided they are consistent with current contextual constraints (an inclusion process). B-U flow of information through a narrow window of attention then leads to the inactivation (exclusion) of nodes that are inconsistent with the sampled information, thereby reducing the number of possible words. Recognition occurs when the serially sampled information leads to the inactivation of all but one word node. It will be shown that there are algorithms for moving attention that make the exclusion process efficient. These algorithms make use of T-D connections to compute the relative probability of each feature, given the set of still possible words. Algorithms to move attention using both this T-D information and B-U information about which features are actually present can exclude a large fraction of words on each cycle. A diagram of the information flow is given in FIG. 1. What follows is a more detailed description of these processes.

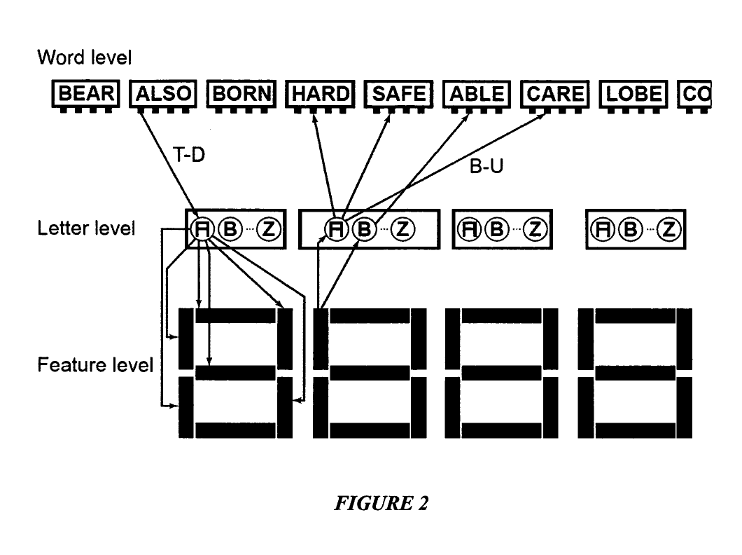

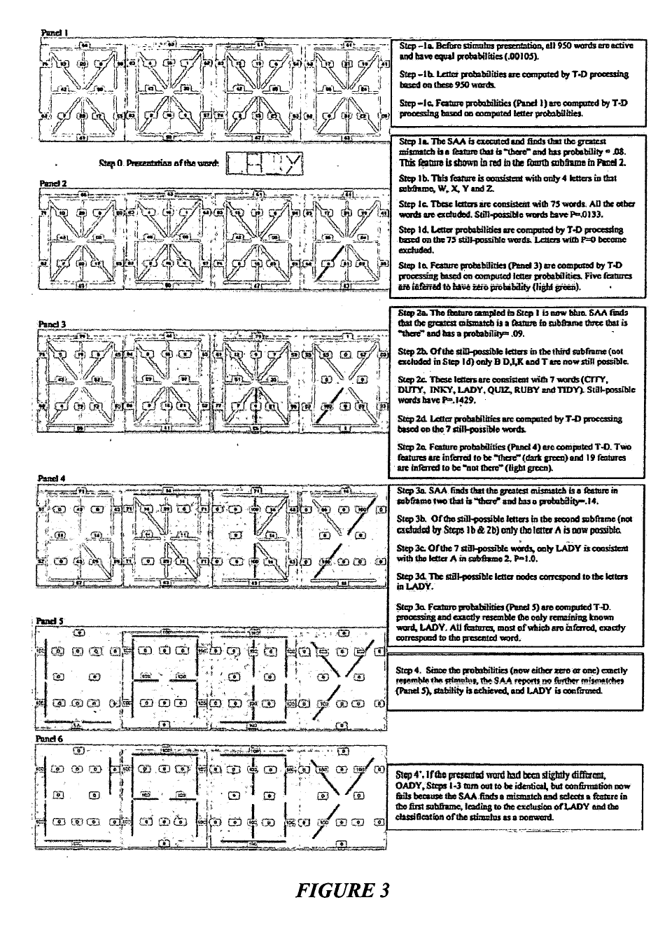

Properties of the hierarchical levels: At the feature level, there is a frame for the detection of 4-letter words with a subframe for each letter (FIG. 2). Within each subframe there are 14 feature detectors used to distinguish letters in the font applicants have used (FIG. 3; note simplified font in FIGS. 1 & 2). These detectors are sensitive to oriented line segments in a manner similar to the simple cells of VI. For simplicity, it is assumed that the sensory input drives the feature detectors between two states, “there” and “not there.” This binary simplification is warranted, given the high contrast stimuli used to obtain the experimental results sought to account for. At the letter level there are 4 subframes, one for each letter position. Each subframe has 26 nodes representing each of the possible letters. At the word level, each node represents one of the stored common (non-pejorative) English 4-letter words (typically 950). In the computer implementation feature nodes receive input from pixel nodes having differing positions along a line segment, as in the Rumelhart (1971) model. However, because this pixel processing does not affect the function of the model, it will not be discussed further.

Specification of T-D and B-U connections: Collectively, the highly specific connections in the model represent the long-term memory of the structure of letters and words. These connections obey a simple “compositional rule”: word nodes make T-D excitatory connections to all the letter nodes that compose the word; similarly letter nodes are connected to the feature nodes that compose the letter (FIG. 2). B-U connections connect features to all the letter nodes that contain that feature; similarly letter nodes are connected to the word nodes that contain that letter (FIG. 2).

Recognition by exclusion of all but one word: It is assumed that at the start of the recognition process the word nodes for contextually possible words are active. This leads to activity at letter and feature levels as computed by T-D linear summation processes and provides information used by the selective attention process (see below). The B-U flow from each feature selected by attention will strongly excite all letter nodes that contain the feature and these will excite the word nodes that contain these letters. Those nodes that do not receive excitation are assumed to be strongly inhibited by those that do, and this inhibition persists for the rest of the recognition process. Applicants term this the process of “exclusion”. The major phase of the recognition process is completed when all but one of the initially possible words has been excluded. This is sufficient for recognition if the subject can be certain that the items being presented are known words. If the task is such that the subject cannot be certain, an additional cycle, termed the “confirmation phase,” is required. This will be described later.

It is further assumed that the activation of word nodes is normalized; as word nodes are excluded, the activity of the remaining active word nodes increases accordingly. As a result, the activity level is inversely proportional to the number of still possible words and represents word probability. Thus, for the word node corresponding to the presented word, the probability will increase from a small value at the start of the recognition process to a value of 1 when recognition occurs. An important consequence of normalization is that the compositional rule for T-D processing leads straightforwardly to the computation of feature probabilities, which can then be used to efficiently move attention (see below).

A Selective Attention Algorithm (SAA) moves the window of attention during each cycle of the iterative recognition process. Although research shows that attention can be more complex than a simple “window,” location is nevertheless always important ((Snyder 1972; Nissen 1985; Tsal and Lavie 1988; Mozer and Sitton 1998; Bichot et al. 1999; Chun 2001), and it is the movement of attention to different locations that applicants address in their model. The aperture of the window of attention has not been established with certainty (Chun 2001); therefore in an initial model the worst case assumption is made that the window is very small and transmits only a single feature. If recognition under these conditions is feasible, it will only be more so if the window of attention is widened. The SAA operates “attentional gating nodes” (FIG. 1), a concept that was incorporated into several previous models of attention, e.g., (Tsotsos et al. 1995; Cave 1999). These allow the further upward signal flow only if attention is moved to this node by the SAA. The output from a single feature node (perhaps in VI) is then transmitted B-U to higher-level cortical regions where it leads to the exclusion of the still-possible letters and words that do not contain it. This is followed by T-D computation of a new feature probability landscape, which is then used by the SAA to determine the next location of attention. This model posits continual T-D/B-U processing cycles, each adding the information from a single feature to the accumulating knowledge base associated with the object being recognized. Various algorithms for moving the window of attention will be considered later. These make different use of the available T-D and B-U information described in the next two sections.

T-D processing computes feature probabilities from word probabilities: Consider first the case when only one word node is active. It will excite the letter nodes contained in the word; the letter nodes (for each of the 4 positions) will then excite the features contained in those letters. Thus in this case, the feature probability landscape will resemble the word itself. If two words are active, linear summation processes will produce a feature probability landscape that looks like the summation of two words, with features contained in both words twice as active as features contained in only one. The same logic applies for any number of still-possible words. Thus the feature probability will be directly proportional to the number of still-possible words that contain that feature. FIG. 3 (Panel 1) shows the a-priori feature probabilities for the set of 950 words that are stored in the long-term memory of the system. It is of interest that the probabilities of features are uneven. For instance, the diagonal features are relatively rare. Thus, the landscape reflects constraints due to high-level context (which can reduce the number of possible words), the feature composition of letters and the letter composition of words. This probability landscape is a source of information available to the SAA even before a word is displayed. During recognition (FIG. 3, steps 1-4), the number of still-possible words is gradually reduced, and this, in turn, leads to changes in word probabilities, letter probabilities, and the feature probability landscape.

Low level B-U processing determines which features are “there” and “not there”: Another source of information available to the SAA is the result of continuous parallel low-level B-U processing of the stimulus from the retina to the primary projection area (VI). This specifies which of the 56 features are “there” (i.e., have contrast) and which are not.

Example of the Recognition Process

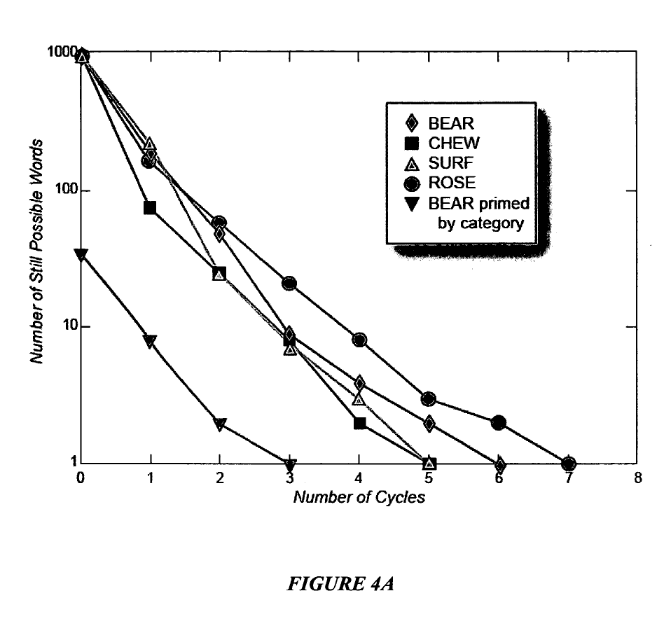

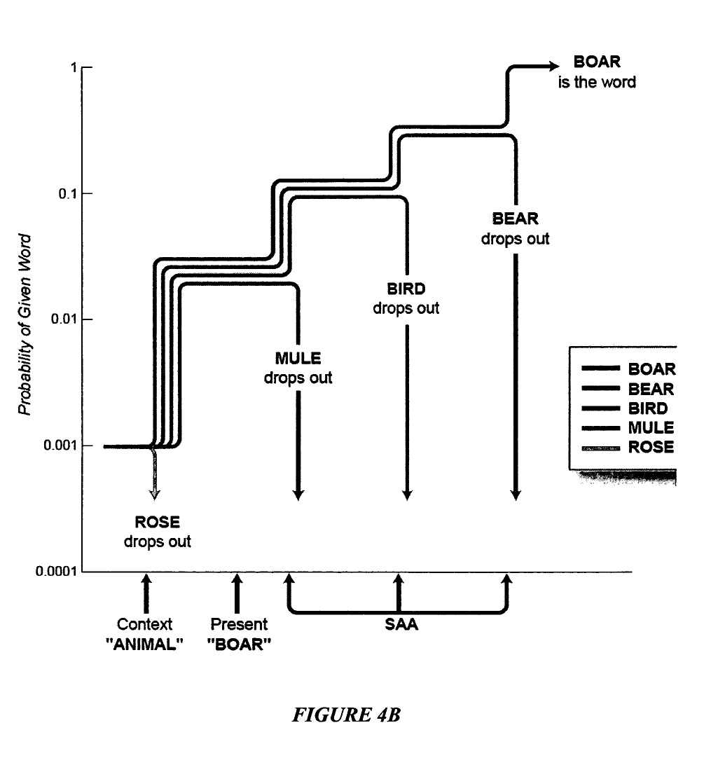

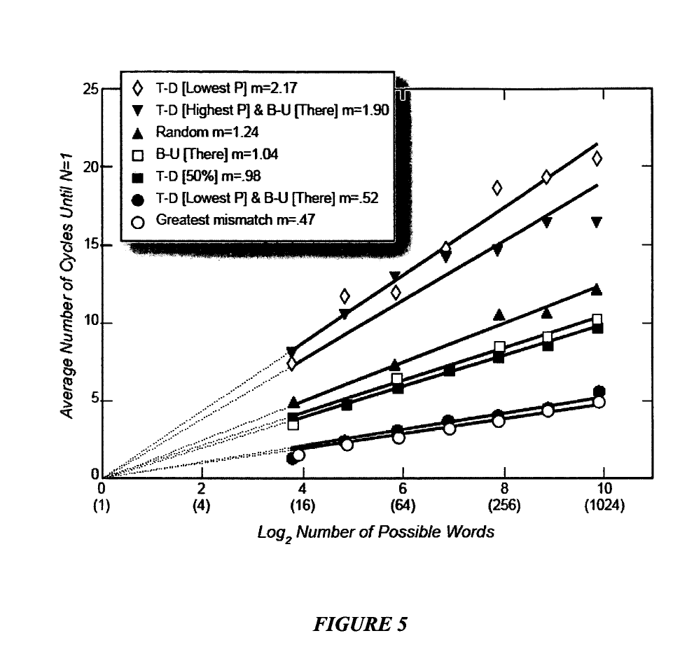

A detailed example of the recognition of a known word, LADY, is shown in FIG. 3. In this example the SAA uses both T-D and B-U information and selects the feature that is “there” which has the lowest probability. In the period before the item is presented, all of the 950 words are active and have equal low probability. From these probabilities, T-D processing computes the a priori feature probabilities shown in FIG. 3, Panel 1. When the word “LADY” is presented, the recognition process goes through three cycles leading to recognition. In the first cycle all but 75 words are eliminated; on the second all but seven are eliminated; on the third cycle, the only still-possible word is the actual word, LADY. This is a sufficient criterion for recognition if the subject knows that only known words are being presented. This example illustrates the ability of the algorithm to eliminate a large percentage (in this case, >90%) of the remaining possible words on each successive cycle. The interested reader can follow each step of this process in FIG. 3. It is noteworthy that although attention acts at a particular place (i.e., gating nodes), the firing patterns at all levels will change as features, letters and words are excluded. Thus information (a reduction in the number of alternatives) accumulates at all levels during recognition. In the example of FIG. 3, recognition of “LADY” occurred in a small number of steps. FIG. 4A shows the recognition process for four other words, BEAR, CHEW, SURF and ROSE, and illustrates the variability in the number of cycles required for word recognition. Considering 50 randomly-selected cases of word recognition from the set of 950 words, the average was 4.9 cycles.

This form of information processing makes inferences. For example, during recognition of LADY the system inferred that the first letter was L, even though the SAA never moved attention to the first letter position. This inference was based on constraints at the word level: given that the last three letters were ADY, the only known word possible was LADY. The panels in FIG. 3 show (green color) the gradual development of inferred features (features inferred “there,” dark green, P=1; and “not there,” light green, P=0). Note that when there is only one still-possible word, the inferred plus known features exactly resemble the presented word (FIG. 3, Panel 5). In other words, the T-D—computed feature probability map exactly resembles the features of the presented word.

Comparison of Different SAA 's

As illustrated in the example of FIG. 3, it is possible to determine the number of iterative cycles required for recognition of a given known word. By repeating such measurements for different words, one can determine the average number of cycles required for recognition using different SAAs. This number provides a quantitative measure for determining how the recognition process depends on the number of known words and for comparing the efficiency of different SAA's. Within the context of this model, two sources of information are available for selecting each feature. One source is the feature information provided by parallel low-level B-U processing of the stimulus (which features are “there” and “not there”). As a result of such processing the visual stimulus activates a subset of the feature nodes. A second source of information is the feature probability landscape computed T-D. As argued above, T-D connections convert word probabilities into feature probabilities. Though the a-priori word probabilities are equal, the feature probabilities are not equal (FIG. 3). Furthermore, as word probabilities change during the recognition process, the T-D—computed feature probability landscape changes accordingly.

Applicants have explored several different SAA's, which illustrate different ways of utilizing the available B-U and T-D information. For each SAA, the average number of cycles required for recognition was determined for word sets of varying size ranging from 15 to 950. This number is plotted as a function of log₂ of the number of words in long-term memory in FIG. 5. The data were well fit by straight lines (see FIG. 5 caption for details). First is considered an SAA that has predictable properties. This SAA picks a feature that is “there,” as determined by low level B-U processing and that is contained in 50% of the still-possible words (T-D[50%]&B-U[There]). The processing of this feature excludes half the remaining words on each cycle. This implies a slope of 1 when plotted on a log₂ axis. The measured slope is 0.98 in good agreement with prediction. In this case, 1 bit of word-level information is acquired per cycle, since the number of alternative words is reduced by one half per feature acquisition.

Several of the SAA's tested were either less effective or only slightly more effective. These included simply picking a feature at random regardless of whether it was “there” or not; picking a feature that was “there” and expected with highest probability (T-D[Highest P] & B-U[There]); sampling the feature location with the lowest probability irregardless of whether the feature was “there” or not (T-D[Lowest P]), or picking at random only features that were “there” (B-U[There]).

Two other SAA's applicants examined were much more efficient than all the others. The simpler of these is the “unidirectional mismatch” computation (B-U [There] & T-D [Lowest P]. This selects a feature that is “there,” as determined by B-U computation and that has the lowest probability, as determined by T-D processing. The other, the “bidirectional mismatch” computation, considers in addition those features that are expected with highest probability, but are “not there”: whichever form of mismatch is greatest is selected. In the 4-letter word recognition task, this “bidirectional mismatch” algorithm is only slightly more efficient than the “unidirectional mismatch” algorithm. In these two most efficient algorithms, approximately 2 bits of word-level information are acquired per cycle and the average number of remaining words is cut in one fourth by each selection. The observed slopes for these two algorithms are 0.52 and 0.47 respectively.

Three main conclusions can be made on the basis of the data shown in FIG. 5. First, the most efficient SAA's tested use both T-D and B-U information and exclude about twice as many words per cycle than algorithms that use only one source of information. Second, the most important principle that makes for an efficient SAA is to choose a feature with a large mismatch, e.g. a feature that is there, but which is contained in the smallest fraction of the still-possible words. Third, the time required for recognition with the efficient SAA's increases logarithmically with a slope of approximately one half (on log base 2 coordinates) with the number of words in the initial set.

Effects of Contextual Cueing

Next is considered how the recognition process can be affected by contextual information that narrows the range of the initial set of possible words. The hierarchical organization of networks shown in FIGS. 1, 2 could be influenced by a yet higher network whose nodes represent categories of words, such as “animals,” “plants,” etc. In this case, the activity of particular word nodes would depend on whether the higher level category node to which the word belonged were active. If for example contextual information were present that made only the “animal” category node active, only the subset of word nodes that are in the animal category would be active at the start of the recognition process. The simulation in FIG. 4A shows that the availability of this contextual information reduces the initial set size to the 35 animal words in the list of 950 known words and leads to a dramatic reduction in recognition time.

It is instructive to plot how T-D—computed word probabilities change during the recognition process since neurons might have a firing rate related to item (word) probability. Thus, the plots of probability in FIG. 4B may be relatable to electrophysiological data obtained from cortex during the recognition process (see Discussion). It can be seen that when contextual information is introduced (the animal category), the probabilities of word nodes within this context (e.g., BEAR) increase whereas the probabilities of nodes outside this context (ROSE) drop to zero. These changes reflect the fact that when the probabilities of some words fall, the probabilities of the remaining words necessarily rise. Such reciprocal changes in probability can also be seen during the course of the recognition process. Just after the stimulus BOAR is presented, the node for one word (MULE) stops firing after the first execution of the SAA, but BIRD, BEAR and BOAR, which resemble each other, rise in probability. When the next feature is sampled, BIRD is eliminated and after one additional sample BEAR is eliminated. BOAR is now the only remaining word node and will fire maximally. This figure illustrates that when high-level (category level) contextual information is supplied, items within the category rise in probability whereas items outside the category fall in probability. This reciprocal change is indicative of a competitive process. Similarly, this competition is evident throughout the recognition process; whenever the probability of some nodes rise within a given level, the probability of other nodes fall. Nodes representing words similar in shape to the target (e.g. BEAR is similar to BOAR) initially also rise, but then fall off relative to the target at a time that increases as the similarity to the target increases. Feature nodes for both geometrically similar and semantically similar words (e.g. words in the same category) are preferentially selected. This may be viewed as a “filter” for feature selection based on both physical shape and semantic constraints.

Recognition when Nonwords are Possible: Properties of the Confirmation Phase

So far it has been considered how recognition can occur when only known words are presented. If both words and nonwords may be presented, then the exclusion of all but one word does not necessarily imply that this word corresponds to the presented word. For instance, if the nonword OADY is presented, the initial steps in this case are identical to those that occur when LADY is presented (FIG. 3, steps 1-3): after sampling three features, the only remaining known word is LADY. To establish whether all the inferred features correspond or don't correspond to those in the presented item, one additional cycle, which applicants term the “confirmation phase,” is required. Since only one word is active at the word level, the computed feature probabilities will be one for all 19 features that are “there” in LADY and zero for the 37 features that are “not there”. If the word presented is in fact LADY, the SAA in the final cycle finds no mismatch and the word node for LADY will remain active (FIG. 3, Step 4). The system activity is then stable at all levels, confirming the word LADY. If the word presented is OADY, the feature shown in FIG. 3, Panel 6, will be selected in the final cycle. The processing of this feature will exclude LADY, and the presented word must therefore be classified as an unknown word i.e., a “nonword.” It should be noted that in this example, it takes the same number of cycles to classify OADY as a nonword as it takes to confirm LADY. However as shown in the next section, on average, nonwords are classified faster than words.

Processing of Words and Nonwords

In visual search experiments in which subjects search lists for target words, distractors that are nonwords are classified and rejected more quickly than distractors that are words (Graboi 1974). Moreover, nonwords that are very different from words can be rejected more rapidly than nonwords that are similar to words (Graboi, unpublished). To examine whether these effects are captured by the model, two types of 4-letter nonwords were generated: the letters of words in the list of 950 were scrambled to produce nonwords that closely approximate English (“High-Bigram” letter strings), and letter strings that are not word-like (“Low-Bigram” letter strings). For example, the letters in “THAW” can form “WATH” (High-Bigram) or “AWHT” (Low-Bigram). The methods for generating these two types of nonwords are given in the caption of Table 1. The time to classify a letter string as a nonword was taken to be the number of cycles required to eliminate all known words. The criterion for recognition of a word was taken to be the moment when a single word remained and was confirmed. Table 1 shows that it takes the least time on average to classify Low-Bigram letter strings as nonwords. It takes longer to classify High-Bigram letter strings as nonwords and still longer to classify letter strings that are words. This effect occurs because words and nonwords differ statistically in their deviation from the average feature probabilities of words (nonwords will have greater differences); the greater the deviation, the more words can be eliminated on each cycle and the faster the process eliminates all known words.

Studies using rapid serial presentation show that category judgments (e.g. animal/non-animal) can be made in very short period of time (Potter 1976; Thorpe et al. 1996). To explore this condition the simulations shown in FIG. 4 were extended by comparing the processing time required for in-set (animal) and out-of-set (non-animal) words. The average time to recognize an animal word (including confirmation) was 3.2 cycles. In contrast, a non-animal word could be rejected as an animal word more quickly (2.3 cycles on average). This effect was significant at the p<0.005 level (t=3.08, df=18). In 8 of 10 cases when non-animal words were presented, the number of still-possible words jumped from greater than one to zero in a single step.

For example, in a visual word recognition device, the data hierarchy may be a hierarchy of typeface segments, letters and words. The node representing each letter object may thus be connected to all the nodes representing short typographic segments or arcs making up the letter, and these segments are the features populating the next lower level in the hierarchy. Similarly, at the word level, the node representing each word object may be connected to the nodes representing all the letters and letter positions constituting the word object. In operation, initially all high-level nodes representing contextually possible words are active. The class of candidate words may also be a readily determined subset of all words determined by one or more preliminary observations, such as a low resolution scan that determines the approximate number of letters in the next word to be recognized. Thus, the preliminary processing may identify the proper universe of candidates as, e.g. the class of all four letter words.

Recognition machines in accordance with the present invention may be configured to identify different objects by applying different relationships as data organization structures defining the hierarchy of data and its operation, and by employing different sensors suitable for detection of the underlying features relevant to that class of objects.

Thus, the invention is broadly applied to object recognition or abstract object detection systems in a number of fields. Particular devices may be implemented for detection of equipment or structures in images for reconnaissance purposes, or for recognition of geological features or constellations of features indicative of underground structure of interest. In addition, such automated detection and recognition may be applied in robotic systems to enable a robotic agent to perform desired tasks and react rapidly and successfully to changing high level contextual constraints and stimuli, directing attentional movement efficiently to gather relevant or important information with respect to a specified set of high-level contextual constraints—for example, finding an exemplar of a particular category in a cluttered environment containing many non-category exemplars. Systems may also set high level contextual information by recognizing an object or objects and generalizing to the context.

In general, the principals of the invention are advantageously applied to form a recognition system for areas in which large numbers of formal objects or physical substances are to be inspected, by analytic probe techniques and/or by modeling techniques, to identify one or more candidate objects having a desired or hypothesized property or set of features. The search for new drugs and the modeling of molecular conformation for complex biomolecules or other compounds are examples of such recognition systems. For these tasks, one may seek to identify the structure of a compound that will exhibit certain behavior, rather than identify a presented item within a category of already-known items by its detected features and behavior. When there exists a large database of materials whose features have been characterized, one may seek to identify which member of the database corresponds to a presented sample. As in the above-described lexical example, one may proceed by defining the corresponding hierarchical memory, and then iteratively selecting one or more potential features and excluding candidate members of the object node (or category level) set, and setting a new window of attention. By way of example, systems of the invention may be applied to perform classical qualitative analysis in inorganic chemistry, where the “features” may be observed physical traits and/or observable responses to simple reagents or probes, such as a color, release of gas, lines of a flame spectrum, etc. For classical organic chemistry a similar problem may be attacked using as features of the presented sample portions of its infrared, spin resonance or other response spectrum, while for peptides and other life compounds the task becomes more complicated and multidimensional.

Recognition systems of the invention may be constructed with a database wherein the low level features reside in catalogues or compilations from diverse sources. However the hierarchical memory may have intermediate level nodes (corresponding to the letters of the above-described lexical example) composed of groupings of several features. For example, sensor array outputs, survey records or measurement compilations may be inspected to identify patterns not directly measured by the sensors or not initially contemplated by the original questionnaires or data entry, such as environmental niches, geological structures, molecular conformations or other intermediate level objects. Similarly, “object records” may be constructed from plural sources and may represent abstract entities that are to be identified. The relationship between the nodes of the hierarchical database at different levels, whereby detection, presence or activation of a feature at a low level during the recognition process “excites” or keeps active related nodes at intermediate and higher levels, and whereby information from the higher levels guides the detection of, or guides the gating of detected feature information, results in an efficient automated recognition device.

The invention being thus disclosed and several illustrative embodiments described, modifications, variations and adaptations thereof will occur to those skilled in the art, and all such variations, modifications and adaptations are considered to be within the scope of the invention as defined herein and in the appended claims and equivalents thereof.

1. A device for recognition of a presented object, such device comprising
a hierarchical memory (HM) in which is stored a data set representative of candidate objects or events, each candidate object or event having one or more features and said data set being arranged as a hierarchical data set having higher level nodes comprising candidate objects or events and lower level nodes corresponding to features of the candidate objects or events, wherein higher level nodes are associated with corresponding lower level nodes and lower level nodes are associated with corresponding higher level nodes;
a front end module (FEM) responsive to a feature of the presented object or event to produce feature detection information;
a selective attention module (SAM), said SAM modulating flow of said feature detection information so as to determine a reduced set of candidate objects or events as potentially corresponding to the presented object or event, said SAM further receiving information from the higher level nodes for effecting said modulating whereby the device selectively attends feature detection information to progressively exclude candidate objects and identify the presented object or event with enhanced efficiency.

2. The device of claim 1, wherein the device responds to successive feature detection information from the FEM to iteratively reduce remaining candidate objects or events and determine a recognition output indicative that:
a) a remaining candidate object or event corresponds to the presented object or event;
b) no candidate object or event matches the presented object or event;
c) a candidate object constitutes a best match to the presented object or event; or
d) a set of candidate objects or events constitutes a best match to the presented object or event.

3. The device of claim 1, wherein the SAM controls gating nodes of the hierarchical data such that one or more detected features excite corresponding nodes at a higher level to maintain active candidate nodes of the hierarchical data set, and the device excludes non-excited nodes from the set of candidate objects to identify the presented object or event.

4. The device of claim 1, wherein the hierarchical data set supports top-down signal flow to derive a measure of feature probabilities.

5. The device of claim 1, wherein a measure is defined on nodes of the hierarchical data set, and the device applies the measure to direct the FEM or modulate feature detection information.

6. The device of claim 1 wherein the device identifies the presented object or event by a candidate object or event represented by a higher level node of the hierarchical data set, wherein each node at the candidate object or event level represents a different candidate object or event;
such nodes may be at least partially active or inactive;
wherein an inactive node may indicate, for example, that the corresponding object or event is no longer a candidate object or event;
wherein when the recognition process begins, there is a set of candidate objects or events, as indicated by the activity of the corresponding nodes; as recognition proceeds, nodes at the candidate object or event level become inactive and the corresponding candidate objects or events are excluded; and
wherein recognition may then occur when all but one node at the candidate object or event level has become inactive; e.g., all but one object or event has been excluded.

7. The device of claim 1 wherein the hierarchical data set includes one or more higher levels above candidate objects or events corresponding to object or event category or other type of higher level contextual constraint (respectively, relationships among object or event categories or relationships among other types of higher level contextual constraints);
wherein the recognition device defines a set of active candidate objects or events by object or event category, or other type of higher level contextual constraint;
wherein the device may receive the object or event category, or other type of higher level contextual constraint as a user input to narrow the initial class of candidate objects or events, or the device may operate with one or more category or other type of higher level contextual constraint recognition processes to initially determine the category of active candidate objects or events.

8. The device of claim 1, wherein the hierarchical database contains one or more intermediate levels below the candidate object or event level, an intermediate level representing an object or event in terms of compositional elements.

9. The device of claim 8, wherein compositional elements of a lower level are represented by sub-elements they contain.

10. The device of claim 1, wherein nodes at different levels of the hierarchical data set are connected, in bottom-up fashion, to nodes at a higher level according to a compositional rule whereby lower level nodes representing an element or sub element are connected to nodes at the next higher level if the item represented by that node is composed in part by the element or sub-element.

11. The device of claim 1, wherein bottom-up signal processing is arranged such that detection of a feature causes a corresponding feature node of the data set to excite the nodes of the data set connected to said corresponding feature node, and candidate object or event nodes that do not receive excitation become inactive for the remainder of the recognition process whereby nodes representing candidate objects or events that do not contain detected features are progressively excluded during the recognition process.

12. The device of claim 1, wherein the device applies top-down signal processing at intermediate and feature levels to compute a measure of feature probability from the current subset of (non-excluded) candidate objects or events, for example, by summation at each node of top-down signals (specified by the compositional rule) flowing into that node or by another automated procedure for defining a measure.

13. The device of claim 1, wherein the SAM operates in conjunction with the FEM to detect feature information for a feature that:
a) has a low non-zero measure and is present, or
b) has a high measure and is absent, whereby when the feature has low non-zero measure, features having zero measure and objects or events containing said features are excluded from the candidate set allowing compact processing.

14. The device of claim 1, wherein the SAM attends to feature information by applying at least one selection process chosen from among the set of processes consisting of:
a) a random selection process;
b) a unidirectional selection process; and
c) a bidirectional selection process (such as “greatest mismatch” for example is detected to be present but has the lowest non-zero probability of being present; or is determined to be not present, but has the highest probability based on the currently active nodes).

15. The device of claim 1, wherein an initial set of candidate objects or events that may, for example, be determined by pre-existing information (such as context) is processed to set measures of feature probabilities before the object or event is presented, and thereafter when the object or event is presented, the FEM detects feature information and the SAM applies said measures to open certain gating nodes, so that bottom-up processing in the hierarchical data set excludes a fraction of the candidate objects or events. A new measure of feature probability may then be computed top-down based on remaining non-excluded candidate objects or events, and cycles may be iterated until recognition occurs when there is only a single candidate object or event a determination is made that no match exists, or a close match is found.

16. A method of identifying a presented object or event by determining a corresponding object or event from among a set of candidate objects or events, such method comprising the steps of:
a) constructing a hierarchical data set wherein the data set includes a level of candidate object or event nodes hierarchically connected with a level of feature nodes;
b) selectively detecting at least one feature of the presented object or event, said feature corresponding to a feature node of the data set; and
c) excluding candidate object or event nodes that are not connected to the feature node corresponding to the selectively detected node so that steps b) and c) reduce the number of candidate objects or events, leading to recognition of the presented object or event.

17. The method of claim 16, wherein said selective detecting is carried out by attending to one or more features based on a feature measure determined from the set of candidate objects or events.

18. The method of claim 16, wherein the features constitute parts of the candidate objects or events, and the feature measure is defined by counting parts corresponding to the set of candidate objects or events and normalizing the counts.

19. The method of claim 16, wherein the selective detecting is carried out by selecting a feature that is determined to be:
i) absent, but have a high measure; or
ii) present but have a low non-zero measure;
so that step c) substantially reduces the set of candidate object or event nodes.

20. The method of claim 16, wherein the candidate objects are chemical or biological formulae.

21. The method of claim 16, wherein the hierarchical data set includes nodes intermediate to the feature nodes and the object or event nodes.

22. A recognition method for identifying a presented stimulus, such method comprising the steps of:
a) presenting an input stimulus for recognition;
b) identifying a set of candidate objects or events, the candidate objects or events possessing features, wherein the candidate objects or events and features form an interconnected hierarchy wherein an object or event node at a higher level is linked to feature nodes at a lower level corresponding to the object or event node, and wherein a feature node at the lower level is linked to one or more corresponding object or event nodes;
c) assigning a measure to features at the lower level, setting a window of attention identifying feature domain information of interest, detecting a feature in the window of attention, wherein said setting a window of attention is performed responsive to said measure so that processing of the detected feature efficiently reduces the candidate set; and
d) re-defining the set of candidate objects or events consistent with the detection of said feature.

23. The recognition method of claim 22, wherein the steps c) and d) are repeated to iteratively reduce the candidate set to a single candidate, thereby identifying the presented object or event.

24. The recognition method of claim 22, wherein the detection is carried out simultaneously of plural features in plural windows of attention to reduce the candidate set.

25. The recognition method of claim 22, wherein the step of selecting a window of attention is performed by selecting a window including a feature having a high measure or a low non-zero measure.

26. A recognition device comprising a processor, at least one feature detector or input receiving device for receiving a feature detection input, and a hierarchical database having nodes at a lower level corresponding to features hierarchically connected to nodes at a higher level corresponding to candidate objects or events, wherein the processor is operative to carry out processing for identifying a presented object or event by determining a corresponding object or event from among a set of candidate objects or events by implementing the following steps:
a) constructing a hierarchical data set wherein the data set includes a level of candidate object or event nodes hierarchically connected with a level of feature nodes;
b) selectively detecting at least one feature of the presented object or event, said feature corresponding to a feature node of the data set; and
c) excluding candidate object or event nodes that are not connected to the feature node corresponding to the selectively detected node so that steps b) and c) reduce the number of candidate objects or events, leading to recognition of the presented object or event.

27. The recognition device of claim 26, wherein the candidate objects or events are objects or events selected from one of the groups of objects or events including physical objects or events, abstract objects or events and abstract representations of physical objects or events.

28. The device of claim 5, wherein nodes having zero measure are excluded from an active data set thereby enhancing operation by processing a smaller data set.
